(19) United States
(12) Patent Application Publication
(10) Pub. No.: US 2025/0317906 A1
(43) Pub. Date: Oct. 9, 2025

(54) ARTIFICIAL INTELLIGENCE BASED NETWORK SLICING MANAGEMENT IN WIRELESS COMMUNICATION NETWORKS

(71) Applicant: T-MOBILE INNOVATIONS LLC, Overland Park, KS (US)

(72) Inventor: Wafik Abdelshahid, Kenmore, WA (US)

(21) Appl. No.: 18/630,272

(22) Filed: Apr. 9, 2024

(51) Int. Cl. H04W 72/04

(52) U.S. Cl. CPC H04W 72/04

(57) ABSTRACT

Various embodiments comprise a wireless communication network. The wireless communication network comprises access network circuitry. The access network circuitry generates feature vectors based on Key Performance Indicator (KPI) values associated with network conditions for an access network, wherein the access network comprises a network slice. The access network circuitry provides the feature vectors to a machine learning model trained to output values corresponding to slice parameters associated with the network slice. The access network circuitry configures the slice parameters of the network slice using the values output by the machine learning model. The access network circuitry serves a wireless user device over the network slice.

### TECHNICAL FIELD

Various embodiments of the present technology relate to network slicing, and more specifically, to performing machine learning slice parameter selection based on network conditions.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources to provide a specific service. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), and Massive Internet-of-Things (MIoT). By implementing network slicing, wireless communication networks optimize the computing and radio resources for specific service types thereby enhancing the overall user experience. Each network slice type comprises service parameters like QoS, RAN configurations, latency, throughput, bit rate, and other metrics that define the level and type of service provided by the slice. However, in conventional networks these slicing parameters are static. Given that wireless communication networks are complex and dynamic environments, the static slicing parameters inhibit wireless networks from optimizing service to user devices on a given network slice in response to a change in network conditions. Unfortunately, wireless communication networks do not effectively and efficiently configure network slices in response to dynamic network conditions.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises generating feature vectors based on Key Performance Indicator (KPI) values associated with network conditions for an access network, wherein the access network comprises a network slice. The method further comprises providing the feature vectors to a machine learning model trained to output values corresponding to slice parameters associated with the network slice. The method further comprises configuring the slice parameters of the network slice using the values output by the machine learning model. The method further comprises serving a wireless user device over the network slice.

Some embodiments comprise a wireless communication network. The wireless communication network comprises access network circuitry. The access network circuitry generates feature vectors based on KPI values associated with network conditions for an access network, wherein the access network comprises a network slice. The access network circuitry provides the feature vectors to a machine learning model trained to output values corresponding to slice parameters associated with the network slice. The access network circuitry configures the slice parameters of the network slice using the values output by the machine learning model. The access network circuitry serves a wireless user device over the network slice.

Some embodiments comprise one of more non-transitory computer readable storage media having program instructions stored thereon. When executed by a computing system, the program instructions direct the computing system to perform operations. The operations comprise generating feature vectors based on KPI values associated with network conditions for an access network, wherein the access network comprises a network slice. The operations further comprise providing the feature vectors to a machine learning model trained to output values corresponding to slice parameters associated with the network slice. The operations further comprise configuring the slice parameters of the network slice using the values output by the machine learning model. The operations further comprise serving a wireless user device over the network slice.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates a wireless communication network.

FIG. 4 illustrates an exemplary operation of the wireless communication network.

FIG. 5 illustrates an exemplary operation of the wireless communication network.

FIG. 6 illustrates a Fifth Generation (5G) communication network.

FIG. 7 illustrates a 5G User Equipment (UE) in the 5G communication network.

FIG. 8 illustrates a 5G Radio Access Network (RAN) in the 5G communication network.

FIG. 9 illustrates a Network Function Virtualization Infrastructure (NFVI) in the 5G communication network.

FIG. 10 further illustrates the NFVI in the 5G communication network.

FIG. 11 illustrates an exemplary operation of the 5G communication network.

FIG. 12 illustrates an exemplary operation of the 5G communication network.

FIG. 13 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

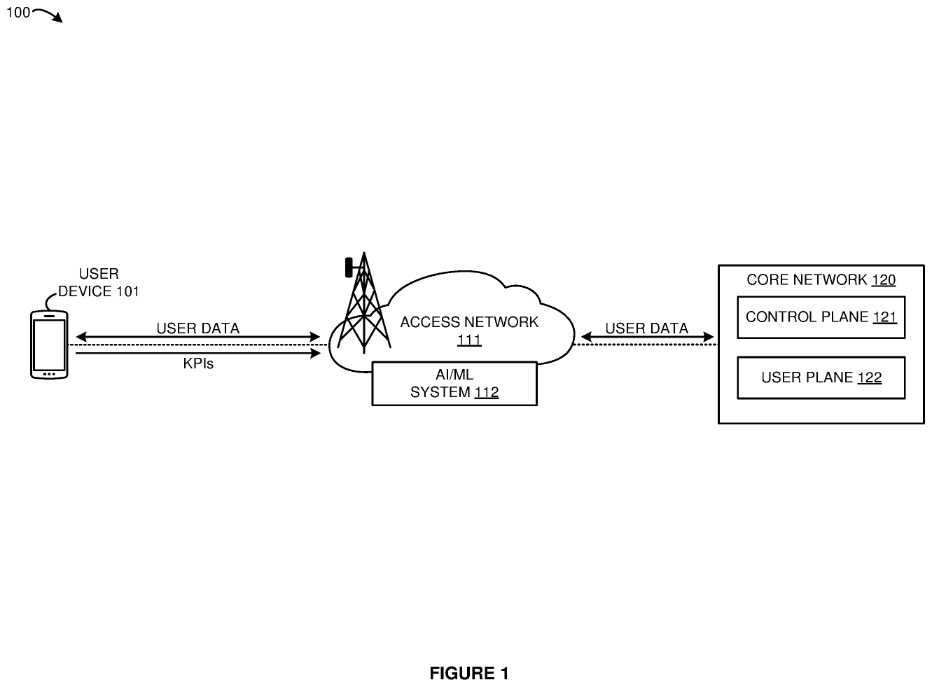

FIG. 1 illustrates communication network 100 to perform machine learning slice parameter selection based on network conditions. Communication network 100 delivers services like media-streaming, internet-access, voice/video calling, text messaging, machine communications, or some other wireless communications product. Communication network 100 comprises user device 101, access network 111, and core network 120. Access network 111 comprises artificial intelligence (AI)/machine learning (ML) system 112. Core network 120 comprises control plane 121 and user plane 122. In other examples, communication network 100 may comprise additional or different elements than those illustrated in FIG. 1.

Various examples of network operation and configuration are described herein. In some examples, user device 101 attaches to core network 120 over access network 111. Core network 120 serves user device 101 over a network slice that includes portions of access network 111. A network slice comprises a collection of user plane, control plane, and access network elements grouped to provide a service type to user devices. Exemplary slice types include low-latency slices, high-bandwidth slices, and the like. User device 101, access network 111, and core network 120 exchange user data over the network slice. User device 101 generates Key Performance Indicators (KPI) values that characterize the network conditions for access network 111. For example, the KPI values may include signal strength, throughput, received latency, interference, and/or other metrics that characterize the performance of the network slice of access network 111. Access network 111 obtains the KPI values from user device 101 and provides the KPI values to artificial intelligence/machine learning system 112. For example, access network 111 may convert the KPI values into feature vectors and provide the vectors to artificial intelligence/machine learning system 112. Artificial intelligence/machine learning system 112 recommends slice parameters to modify the service over access network 111 based on the feature vectors. Access network 111 configures the network slice using the slice parameters recommended by machine learning system 112.

Communication network 100 provides wireless data services to wireless user devices like device 101. Exemplary wireless data services include internet-access, media-streaming, social-networking, and machine-control. Exemplary wireless user devices comprise phones, computers, vehicles, robots, and sensors. Access network 111 comprises an example of a Radio Access Network (RAN). RANs exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores like core network 120. The RANs are connected to the wireless network cores over backhaul data links. Access network 111 and core network 120 may communicate via edge networks like internet backbone providers, edge computing systems, or another type of edge system to provide the backhaul data links between node 111 and core network 120.

The RANs (e.g., access network 111) comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120. Access network 111 hosts artificial intelligence/machine learning system 111. Artificial intelligence/machine learning system 111 comprises one or more algorithms trained to select slice parameters based on network conditions.

Core network 120 is representative of computing systems that provide wireless data services to user device 101 over access network 111. Exemplary computing systems comprise Network Function Virtualization (NFVI) systems, data centers, server farms, cloud computing networks, hybrid cloud networks, and the like. The computing systems of core network 120 store and execute the network functions to form control plane 121 and user plane 122. Control plane 121 may comprise network functions like Access and Mobility Management Function (AMF), Session Management Function (SMF), Network Slice Selection Function (NSSF), Unified Data Management (UDM), Network Slice Management Function (NSMF), and Network Data Analytics Function (NWDAF), and the like. User plane 122 may comprise network functions like User Plane Function (UPF) and the like. Core network 120 may comprise a Fifth Generation Core (5GC) architecture or another type of core network architecture.

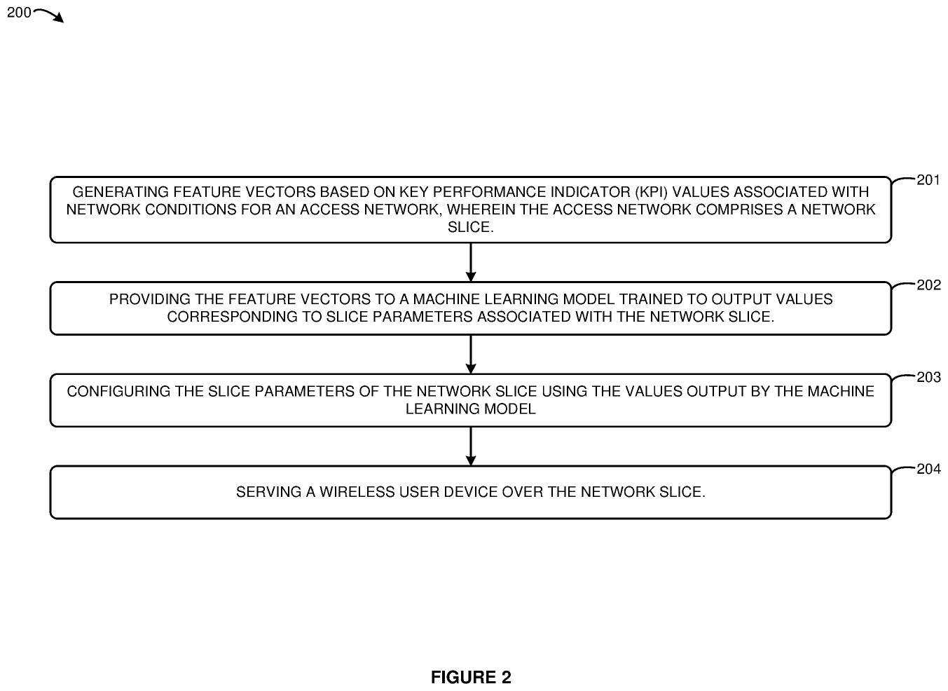

FIG. 2 illustrates process 200. Process 200 comprises an exemplary operation of communication network 100 to perform machine learning slice parameter selection based on network conditions. The operation may vary in other examples. The operations of process 200 comprise generating feature vectors based on KPI values associated with network conditions for an access network, wherein the access network comprises a network slice (step 201). The operations further comprise providing the feature vectors to a machine learning model trained to output values corresponding to slice parameters associated with the network slice (step 202). The operations further comprise configuring the slice parameters of the network slice using the values output by the machine learning model (step 203). The operations further comprise serving a wireless user device over the network slice (step 204).

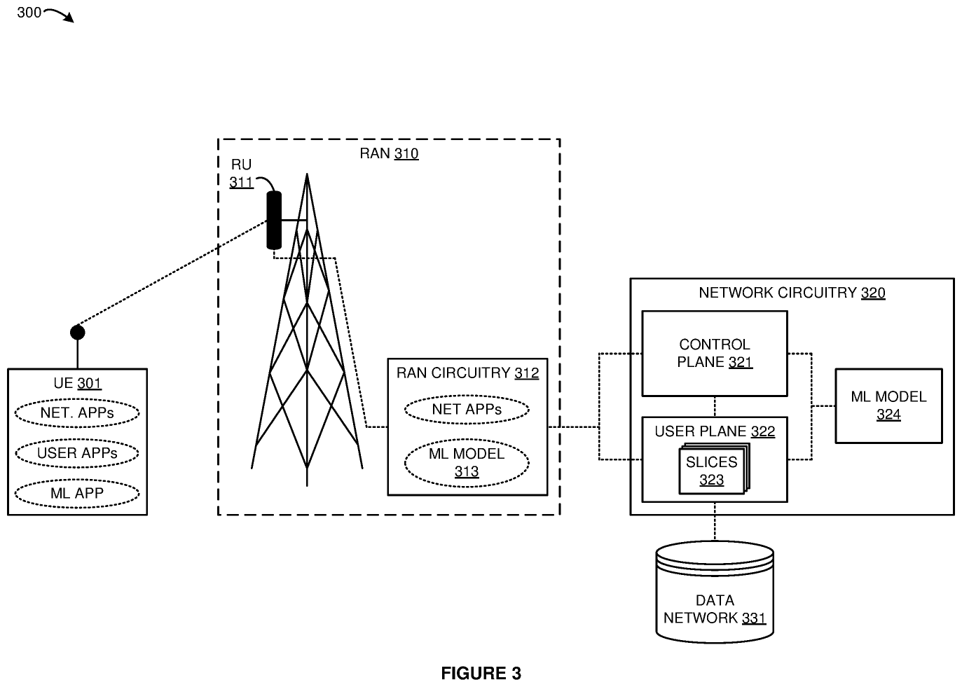

FIG. 3 illustrates wireless communication network 300 network to perform machine learning slice parameter selection based on network conditions. Wireless communication network 300 is an example of communication network 100, however network 100 may differ. Wireless communication network 300 comprises User Equipment (UE) 301, RAN 310, network circuitry 320, and data network 331. UE 301 hosts network applications (NET. APPs), user applications (USER APPs), and a machine learning application (ML APP). RAN 310 comprises Radio Unit (RU) 311 and RAN circuitry 312. RAN circuitry 312 hosts network application sand machine learning model 313. Network circuitry 320 comprises control plane 321, user plane 322, and machine learning (ML) model 324. User plane 322 comprises network slices 323. In other examples, wireless network communication network 300 may comprise additional or different elements than those illustrated in FIG. 3.

In some examples, UE 301 attaches to network circuitry 320 over RAN 310. Control plane 321 selects one or more of slices 323 for UE 301 and directs user plane 322 to serve UE 301 the selected slices. UE 301 launches the user application and exchanges user data with user plane 322 over the selected network slices that traverse RAN 310. User plane 322 exchanges the user data with data network 331. As UE 301 participates in the session, the machine learning application hosted by UE 301 generates KPI values that characterize the radio conditions for RAN 310 at the location of UE 301. Similarly, the network applications hosted by RAN circuitry 312 generate KPI values that characterize network conditions in RAN 310. UE 301 wirelessly indicates the KPI values generated by UE 301 to RAN 310. RAN circuitry 312 obtains the KPI values generated by UE 301. RAN circuitry 312 generates feature vectors that numerically represent the KPI values generated by the network applications and the KPI values obtained from UE 301. For example, one of the feature vectors may comprise a string of integers that describe the received signal strength at UE 301. RAN circuitry 312 provides the feature vectors to machine learning model 313. Machine learning model 313 processes the feature vectors using algorithms trained to output slice parameters based on network conditions. RAN circuitry 312 obtains a machine learning output generated by model 313. The output comprises slice parameters for the one of network slices 323 serving UE 301. RAN circuitry 312 configures the slice using the parameters and serves UE 301 the network slice.

Advantageously, wireless communication network 300 effectively and efficiently utilizes machine learning techniques to configure network slices to optimize service to UE 301 based on live network conditions. Moreover, wireless communication network 300 increases the efficiency of network resource allocation by enabling/disabling network slice features based on live network conditions.

UE 301 and RAN 310 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 310, network circuitry 320, and data network 331 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a vehicle, drone, robot, computer, phone, sensor, or another type of data appliance with wireless and/or wireline communication circuitry. Although RAN 310 is illustrated as a tower, RAN 310 may comprise another type of mounting structure (e.g., a building), or no mounting structure at all. RAN 310 comprises a Fifth Generation (5G) RAN, LTE RAN, gNodeB, eNodeB, NB-IoT access node, trusted non-Third Generation Partnership Project (3GPP) access node, untrusted non-3GPP access node, LP-WAN base station, wireless relay, WIFI hotspot, Bluetooth access node, and/or another wireless or wireline network transceiver. UE 301 and RAN 310 comprise antennas, amplifiers, filters, modulation, analog/digital interfaces, microprocessors, software, memories, transceivers, bus circuitry, and the like. Control plane 321 comprises network functions like AMF, SMF, NSSF, NSMF, NWDAF, and the like. User plane 322 comprises network functions like UPF and the like. Data network 331 comprises an application server that hosts applications (e.g., media streaming applications) for UE 301.

Machine learning model 313 and machine learning model 324 comprise any machine learning model or artificial intelligence system implemented within network 300 trained to recommend network slice parameters, identify suitable network slices, request the creation of new slices, request the removal of existing slices, and the like. A machine learning model comprises one or more artificial intelligence/machine learning algorithms that are trained based on historical data and/or other types of training data associated with wireless communication networks. A machine learning model may employ one or more machine learning algorithms through which data can be analyzed to identify patterns, make decisions, make predictions, or similarly produce output. Examples of machine learning algorithms that may be employed solely or in conjunction with one another include Large Language Models (LLMs), Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data. In some examples, the machine learning application hosted by UE 301, model 313, and model 324 are representative of a distributed machine learning application.

UE 301, RAN 310, network circuitry 320, and data network 331 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 300 as described herein.

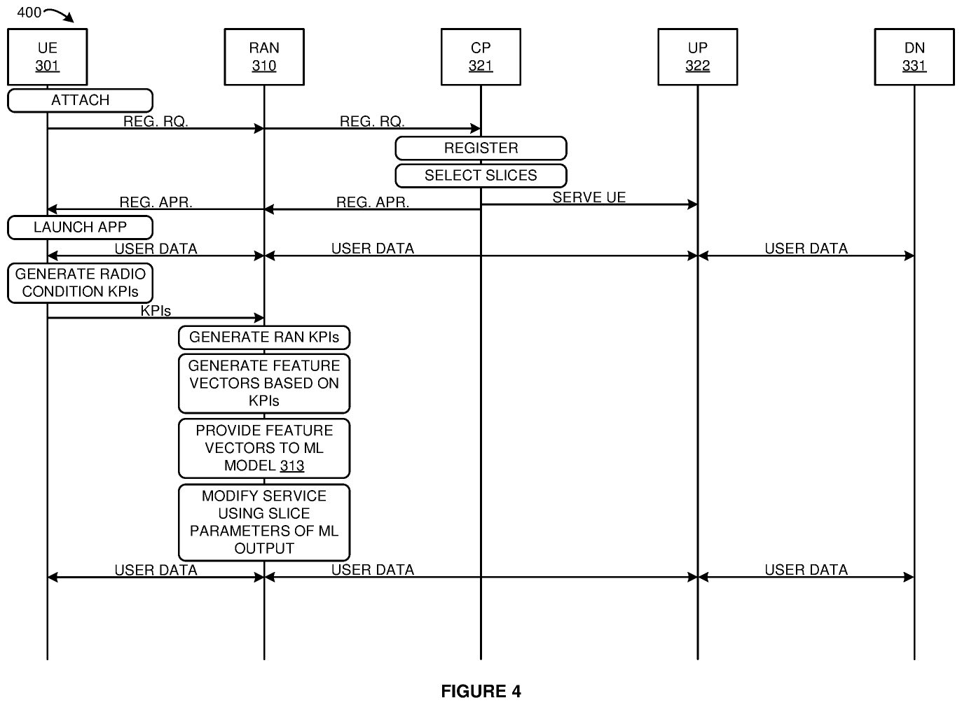

FIG. 4 illustrates process 400. Process 400 comprises an exemplary operation of wireless communication network 300 to perform machine learning slice parameter selection based on network conditions. Process 400 comprises an example of process 200 illustrated in FIG. 2, however process 200 may differ. The operation may vary in other examples. In some examples, UE 301 wirelessly attaches to RAN 310. The network applications in UE 301 exchange signaling with the network applications hosted by RAN circuitry 312 to establish a signaling link between UE 301 and network circuitry 320. Once established, UE 301 generates and transfers a registration request (REG. RQ.) to control plane 321 over RAN 310. Control plane 321 processes the request and registers UE 301 for service on network 300. In response to successful registration, control plane 321 selects ones of slices 323 to serve UE 301. For example, UE 301 may include a Single Network Single Slice Selection Assistance Information (S-NSSAI) in the registration request and control plane 301 may select one of slices 323 that correspond to the S-NSSAI indicated by UE 301. Exemplary network slice types include Ultra-Reliable Low Latency Communication (URLLC), Enhanced Mobile Broadband (eMBB), Massive Internet-of-Things (MIOT), and the like. Typically, UE 301 will request slice types that correspond to the session type(s) that UE 301 intends to engage in. For example, when UE 301 requests a session of a low-latency application, UE 301 may request a URLLC slice to support the session.

Control plane 321 directs user plane 322 to serve UE 301 the selected slices. Control plane 321 transfers a registration approval message to UE 301 over RAN 310 directing UE 301 to begin its session. The registration approval message typically includes information like network addresses, selected S-NSSAIs, and/or other information for UE 301 to use to facilitate communication with user plane 322. In response to a user input, UE 301 launches a user application. The user application executing on UE 301 generates user data for the session. UE 301 wirelessly transfers uplink user data to RAN 310. RAN 310 transfers the uplink data to user plane 322 which forwards the user data to data network 331. Data network 331 generates downlink user data and transfers the downlink user data to user plane 322. User plane transfers the downlink data to UE 301 over RAN 310.

As UE 301 participates in the session, the machine learning application hosted by UE 301 generates KPIs that characterize radio conditions at the location of UE 301. For example, the machine learning application may drive the network applications hosted by UE 301 to measure Received Signal Received Quality (RSRQ), Received Signal Received Power (RSRP), Signal-to-Noise Ratio (SINR), transmit power, power headroom, and the like. The machine learning application also derives application specific KPIs like session requirements, active slices, required latency, required throughput, received latency, and data throughput for the user application executing on UE 301. UE 301 indicates the KPIs derived by the machine learning application to RAN 310.

Contemporaneously, the network applications hosted by RAN circuitry 312 derive RAN specific KPIs to supplement the KPIs received from UE 301. It should be appreciated that UE 301 may not have access to every KPI describing network conditions on RAN 310. For example, UE 301 is typically ignorant of the loading on RAN 310 or backhaul link conditions between RAN 310 and user plane 322. The network applications in RAN circuitry 312 determine additional KPIs like RAN load, backhaul data throughput, Radio Access Technology (RAT) types, bands, and the like. The network applications (or model 313) convert the KPIs generated by UE 301 and RAN 310 into numeric values and groups the numeric values into feature vectors interpretable by model 312. Feature vectors comprise numeric representations of data interpretable by a machine learning algorithm. For example, the network applications may assign different numeric values to RSRP measurements received from UE 301 and then group the numeric values into a feature vector representing RSRP at the location of UE 301. In some examples, model 313 instead converts the KPIs into the feature vectors.

Network slices comprise service parameters that define the level and type of service the slice provides. Some of these parameters enable specialized features on RAN 310. For example, a low-latency slice may include slice parameters for pre-configuration grant and pre-scheduling while a high-bandwidth slice may include parameters for relative priority scheduling. However, depending on network conditions on a given RAN, the slice parameters may need to be adjusted to optimize service to the UE. Returning to the example, the network applications provide the feature vectors to machine learning model 313. Model 313 processes the feature vectors using its constituent machine learning algorithms and generates a machine learning output. The output comprises a set of updated slice parameters for the network slice(s) of UE 301. Exemplary parameter modifications include enabling/disabling or increasing/decreasing slice parameters like pre-configuration grant, pre-scheduling, and relative priority scheduling for UE 301 over RAN 310. The network applications modify the network slice using the recommended parameters. UE 301, RAN 310, user plane 322, and data network 331 exchange user data on the modified network slice.

For example, UE 301 may be receiving a URLLC slice that has pre-configuration grant and pre-scheduling enabled by default on RAN 310. It should be appreciated that these slice parameters facilitate low-latency communication. In addition, the KPIs generated by UE 301 and RAN 310 may indicate network conditions at UE 301 are excellent (e.g., low loading, low interference, high signal strength, etc.). Model 313 may then generate an output that recommends disabling pre-configuration grant and pre-scheduling for the URLLC slice as the network conditions are sufficient to provide low-latency service to UE 301 without these features being enabled. The network applications in RAN circuitry 312 may then modify the URLLC slice by disabling pre-configuration grant and pre-scheduling over RAN 310 to optimize service to UE 301 while conserving radio and computational resources in RAN 310. Conversely, the KPIs generated by UE 301 and RAN 310 may indicate network conditions at UE 301 are poor (e.g., high loading, high interference, low signal strength, etc.). Model 313 may then generate an output that recommends maintaining pre-configuration grant and pre-scheduling for the URLLC slice as the network conditions are insufficient to provide low-latency service to UE 301 without these features being enabled. The network applications in RAN circuitry 312 may then maintain the default configuration of the URLLC slice to optimize service to UE 301.

For example, UE 301 may be receiving an eMBB slice that has relative priority scheduling enabled by default on RAN 310. It should be appreciated that this slice parameter facilitates high-bandwidth communication. In addition, the KPIs generated by UE 301 and RAN 310 may indicate network conditions at UE 301 are poor. Model 313 may then generate an output that recommends increasing relative priority for UE 301 on the eMBB slice as the network conditions are insufficient to provide high bandwidth service to UE 301 without this feature being increased. The network applications in RAN circuitry 312 may then modify the eMBB slice by increasing the relative priority scheduling over RAN 310 to optimize service to UE 301. Conversely, the KPIs generated by UE 301 and RAN 310 may indicate network conditions at UE 301 are excellent. Model 313 may then generate an output that recommends maintaining disabling relative priority scheduling for the eMBB slice as the network conditions are sufficient to provide high-bandwidth service to UE 301 without this feature being enabled. The network applications in RAN circuitry 312 may then modify the eMBB slice by disabling relative priority scheduling over RAN 310 to optimize service to UE 301 while conserving radio and computational resources in RAN 310.

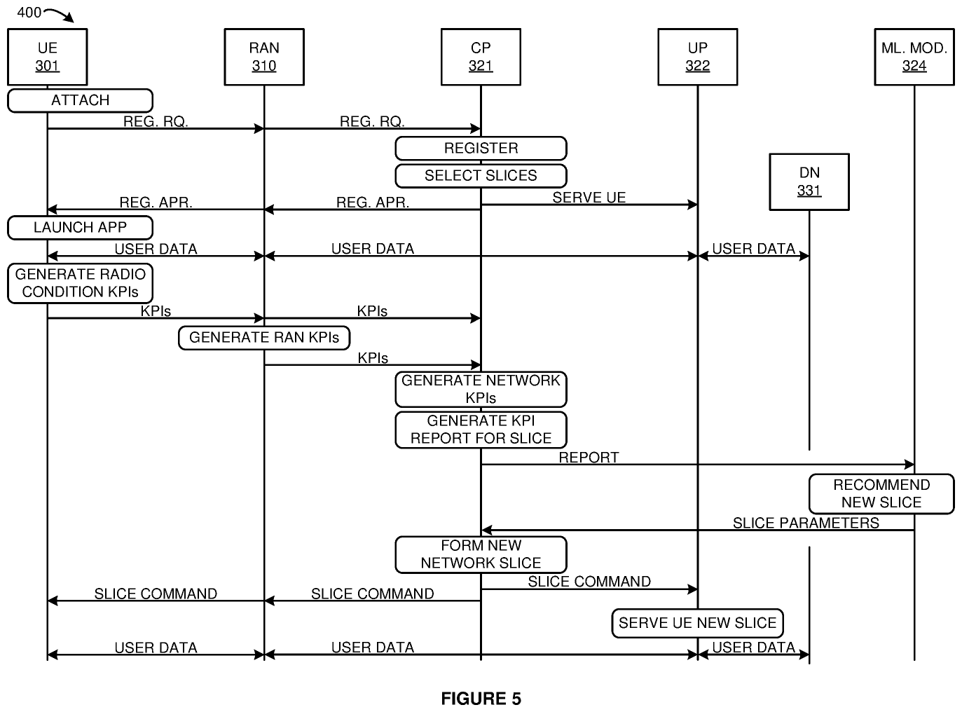

FIG. 5 illustrates process 500. Process 500 comprises an exemplary operation of wireless communication network 300 to perform machine learning slice parameter selection based on network conditions. Process 500 comprises an example of process 200 illustrated in FIG. 2 and process 400 illustrated in FIG. 4, however processes 200 and 400 may differ. The operation may vary in other examples. In some examples, UE 301 wirelessly attaches to RAN 310. The network applications in UE 301 and RAN circuitry 312 establish a signaling link between UE 301 and network circuitry 320. UE 301 transfers a registration request (REG. RQ.) to control plane 321 over RAN 310. Control plane 321 registers UE 301 for service on network 300. In response to successful registration, control plane 321 selects ones of slices 323 to serve UE 301. Control plane 321 directs user plane 322 to serve UE 301 the selected slices. Control plane 321 transfers a registration approval message to UE 301 over RAN 310 directing UE 301 to begin its session. UE 301 launches a user application. UE 301 wirelessly exchanges user data for the application with RAN 310. RAN 310 exchanges the user data with user plane 322. User plane 322 exchanges the user data with data network 331.

As UE 301 participates in the session, the machine learning application hosted by UE 301 generates KPIs that characterize radio conditions at the location of UE 301. For example, the machine learning application may collect KPIs like RSRQ, RSRP, SINR, transmit power, power headroom, session requirements, current slice(s), required latency, required throughput, received latency, data throughput, and/or other metrics that characterize network conditions at the location of UE 301. UE 301 indicates the KPIs derived by the machine learning application to RAN 310. Contemporaneously, the network applications hosted by RAN circuitry 312 derive RAN specific KPIs to supplement the KPIs received from UE 301 like RAN load, backhaul data throughput, RAT types, bands, served slices, and the like. RAN 310 reports the KPIs generated by UE 301 and RAN 310 to control plane 321.

Control plane 321 receives the KPIs from RAN 310. Control plane 321 generates KPIs to characterize network conditions in network circuitry 320. It should be appreciated that UE 301 and RAN 310 may not have access to every KPI describing network conditions in network circuitry 320. For example, UE 301 and RAN 310 are typically ignorant of the signaling load in control plane 321 and user plane 322, the number of network function instances, network function capabilities, and the like. Control plane 321 generates a KPI report comprising all the KPIs received from UE 301 and RAN 310 as well as the KPIs generated by control plane 321 and provides the report to machine learning model 324.

Machine learning model 324 converts the KPIs generated by UE 301, RAN 310, and control plane 321 into numeric values and groups the numeric values into feature vectors interpretable by model 324. In some examples, control plane 321 or other entity in network circuitry 320 converts the KPIs into the feature vectors for model 324. Model 324 processes the feature vectors using its constituent machine learning algorithms to generate a machine learning output. The output comprises a recommendation to create a new network slice and slice parameters for the new slice. Model 324 provides the output to control plane 321.

Control plane 321 interfaces with Orchestration and Management (OAM) to generate a new network slice comprising the service parameters recommended by model 324. OAM is a network layer responsible for allocating computing in network circuitry 320 and is omitted for clarity. For example, control plane 321 may interface with OAM to secure computing resources to instantiate a set of new control plane and user plane functions to form the new slice. Once the new slice is created, control plane 321 directs user plane 322 to serve UE 301 the new slice. Control plane 321 also transfers a slice command to UE 301 directing UE 301 to switch to the new network slice. UE 301, RAN 310, user plane 322, and data network 331 exchange additional user data on the new network slice.

The above operations of network 300 described with respect to FIGS. 4 and 5 utilize artificial intelligence/machine learning techniques to modify existing slices and create new slices based on network conditions and session requirements. It should be appreciated that these techniques may be expanded to other wireless communication network services in addition to network slicing. For example, models 313 and 324 may manage high priority services like Wifi-Protected Setup (WPS) utilizing the machine learning assisted slice management techniques described above.

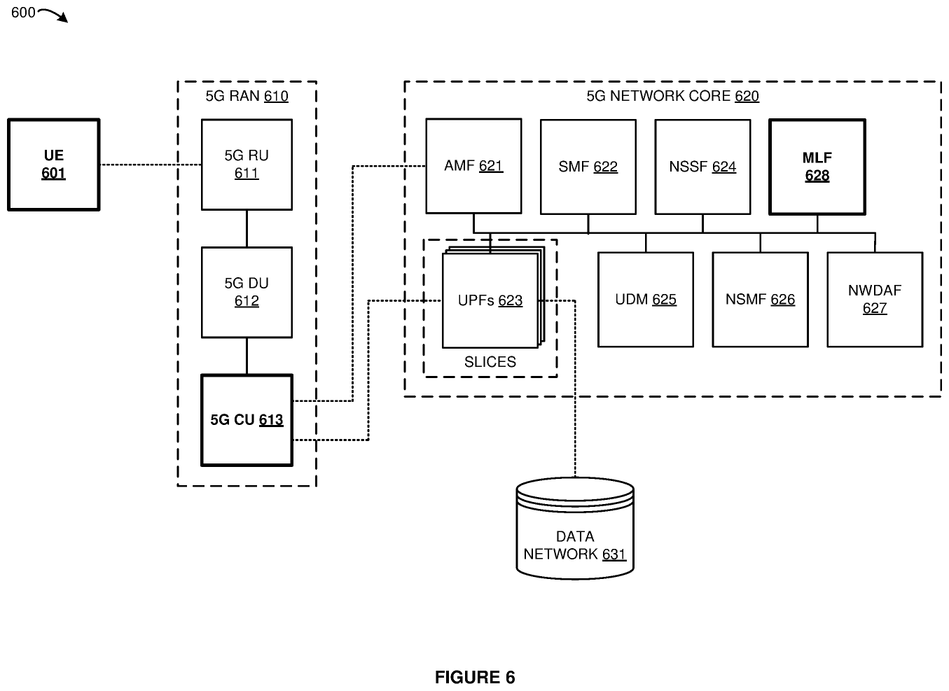

FIG. 6 illustrates 5G communication network 600 to perform machine learning slice parameter selection based on network conditions. 5G communication network 600 comprises an example of communication network 100 illustrated in FIG. 1 and wireless communication network 300 illustrated in FIG. 3, however networks 100 and 300 may differ. 5G Communication network 600 comprises 5G UE 601, 5G RAN 610, 5G network core 620, and data network 631. 5G RAN 610 comprises Radio Unit (RU) 611, Distributed Unit (DU) 612, and Centralized Unit (CU) 613. 5G network core 620 comprises Access and Mobility Management Function (AMF) 621, Session Management Function (SMF) 622, User Plane Functions (UPFs) 623, Network Slice Selection Function (NSSF) 624, Unified Data Management (UDM) 625, Network Slice Management Function (NSMF) 626, Network Data Analytics Function (NWDAF) 627, and Machine Learning Function (MLF) 628. UPF 623s form a variety of network slices. Other network functions and network entities like Authenticating Server Function (AUSF), Unified Data Registry (UDR), Network Repository Function (NRF), Policy Control Function (PCF), Network Exposure Function (NEF), Application Function (AF), Service Communication Proxy (SCP), and Equipment Identity Registry (EIR), are typically present in 5G network core 620 but are omitted for clarity. In other examples, 5G communication network 600 may comprise different or additional elements than those illustrated in FIG. 6.

As illustrated in FIG. 6, the network slices comprise UPFs 623. The slices may comprise URLLC slices, eMBB slices, MIOT slices, metaverse slices, media streaming slices, security slices, gaming slices, and the like. Each slice type comprises a set of default service parameters that define the level of service, type of service, and capabilities of the slice. For example, URLLC slices typically comprise parameters for RAN pre-configuration grant and RAN pre-scheduling to facilitate low-latency communication over the RAN while eMBB slice typically comprise parameters for RAN relative priority scheduling to enhance high-bandwidth communication over the RAN. For purposes of clarity, the slices are illustrated as comprising only UPFs 623, however network slices typically comprise additional network functions and RAN elements in network 600. For example, network core 620 may comprise multiple AMFs and SMFs and the slices may each comprise an AMF and an SMF in addition to UPFs 623. When the slices comprise multiple network functions, some of the network functions may be shared between the network slices. For example, two slices may each comprise SMF 622 while a third slice may comprise another SMF. It should be appreciated that the slices illustrated in FIG. 6 are exemplary and the slice configuration implemented by network core 620 may differ in other examples.

In some examples, UE 601 wirelessly attaches to RAN 610. UE 601 transfers a registration request to AMF 621 over RAN 610. The registration request includes information like registration type, UE capabilities, Network Slice Selection Assistance Information (NSSAI) requests, Protocol Data Unit (PDU) session requests, and the like. In response to the registration request, AMF 621 transfers an identity request to UE 601 over RAN 610. UE 601 transfers an identity indication to AMF 621 over RAN 610. For example, UE 601 may signal a Subscriber Concealed Identifiers (SUCI) to AMF 621 over RAN 610. AMF 621 interacts with other network functions to authenticate the identity of UE 601 and authorize UE 601 for wireless data service. For example, AMF 621 may transfer an authentication request to an AUSF that includes the SUCI for UE 601. The AUSF may then interface with UDM 625 to retrieve authentication data to verify the SUCI of UE 601. The authentication data typically comprises the Subscriber Permanent Identifier (SUPI) for the UE and authentication vectors like an authentication challenge, key selection criteria, and a random number. The AUSF then transfers the authentication data and SUPI to AMF 621. AMF 621 may transfer an authentication challenge, key selection criteria, and random number to UE 601 over RAN 610. UE 601 may hash the random number using its copy of the secret key to generate an authentication response and transfer the response to AMF 621 over RAN 610. AMF 621 then authenticates UE 601 by matching the authentication response generated by the UE with the expected result.

Responsive to the authentication, AMF 621 registers UE 601 for service on network 600. AMF 621 accesses a subscriber profile for UE 601 to generate UE context to serve UE 601. For example, AMF 621 may select UDM 625 to retrieve subscriber information for UE 601. AMF 621 may transfer a context get request to UDM 625 to retrieve subscriber data like QoS metrics, allowed NSSAI, service attributes, service authorizations, and the like from UDM 625. UDM 625 returns the requested information to AMF 621 which generates UE context comprising the information retrieved from UDM 625. AMF 621 may additionally select and register with a PCF to create network policy associations for UE 601.

Once the context is generated, AMF 621 selects NSSF 624 to select a network slice for UE 601. AMF 621 transfers a get request to NSSF 624 to map the NSSAI requested by UE 601 to an available network slice in network core 620. NSSF 624 receives the request and maps the NSSAI included in the get request to a network slice. NSSF 624 returns the slice mapping to AMF 621 which then selects a network slice requested by UE 601. For example, the slices may comprise an URLLC slice, an eMBB slice, an MIOT slice a GBR network slice, and the like. UE 601 may include an S-NSSAI for the URLLC slice in the initial registration request. NSSF 624 may then map the S-NSSAI in the get request to the URLLC slice to identify the network slice for UE 601. In other examples, UE 601 may request multiple network slices and AMF 621 may interface with NSSF 624 to serve UE 601 multiple network slices over RAN 610.

AMF 621 selects SMF 622 to serve UE 601 based on the selected network slice, QoS metrics, requested PDU session, service attributes, and the like. AMF 621 directs SMF 622 to establish the requested PDU session for UE 601 and indicates the S-NSSAI for the selected network slice to SMF 622. SMF 622 selects a corresponding one of UPF 623 to serve UE 601. SMF 622 indicates the network address for the selected one of UPFs 623 to AMF 621. AMF 621 includes the network address in the UE context and transfers the context to UE 601 over RAN 610. UE 601 launches a user application and uses the received UE context to establish a PDU session over the network slice. The user application may comprise a media streaming application, social media application, low-latency application, voice/video conferencing application, online gaming application, extended/virtual reality application, and the like. The user application in UE 601 generates uplink data and UE 601 wirelessly transfers the uplink data to the corresponding one of UPFs 623 over RAN 610. The corresponding one of UPFs 623 transfers the uplink user data to data network 631. Data network 631 generates downlink data for the PDU session and transfers the downlink data to the corresponding one of UPFs 623. The corresponding one of UPFs 623 transfers the downlink user data to UE 601 over RAN 610.

UE 601 generates KPIs characterizing network radio conditions and application performance for the network slices assigned to UE 601. As UE 601 participates in its PDU session, UE 601 measures radio conditions for RAN 610 to generate KPIs like RSRP, RSRQ, and SINR. UE 601 generates additional KPIs describing UE capabilities like transmit power and power headroom. UE 601 measures KPIs that characterize application performance on the network slices like uplink throughput, downlink throughput, and received latency. UE 601 identifies PDU session KPIs like required latency, required throughput, and slice type. UE 601 hosts a machine learning application that comprises algorithms trained to select slice parameters based on the KPIs. UE 601 converts the KPIs into feature vectors and processes the feature vectors using the machine learning application to generate a machine learning output.

The machine learning output recommends new slice parameters and/or UE actions. Exemplary slice parameter recommendations include enabling/disabling or increasing/decreasing slice parameters like pre-configuration grant, pre-scheduling, and relative priority scheduling. Exemplary UE action recommendations include cell reselection, frequency band reselection, slice reselection, access network handover, and the like. Alternatively, the machine learning output may recommend maintaining current slice parameters and/or taking no UE actions. When the recommendation includes new slice parameters, UE 601 wirelessly transfers a request indicating the new slice parameters to RAN 610. RAN 610 receives the request and modifies the service to UE 601 accordingly. When the slice recommendation does not include new slice parameters, UE 601 does not transfer a request to modify the network slice to RAN 610. When the recommendation includes a UE action, UE 601 takes the recommended action (e.g., transferring a handover request, selecting a new frequency band, requesting a new network slice, etc.). When the recommendation does not include a UE action, UE 601 continues the PDU session on the network slice. Alternatively, UE 601 may instead report its KPIs to RAN 610 and/or network core 620 to generate a machine learning recommendation on behalf of UE 601.

Contemporaneously to UE 601 generating KPIs, RAN 610 generates additional KPIs describing network conditions in RAN 610. As RAN 610 serves UE 601 its PDU session over the selected slice, RAN 610 measures network conditions on RAN 610 to generate KPIs like cell loading, backhaul link conditions, downlink throughput, downlink data queues, and the like. RAN 610 hosts a machine learning function that comprises algorithms trained to select slice parameters based on the KPIs. RAN 610 generates feature vectors that numerically represent the KPIs and provides the feature vectors to the machine learning function. The machine learning function processes the feature vectors using its constituent algorithms to generate a machine learning output. The output recommends updated slice parameters, a slice change recommendation, a new slice type recommendation, a slice deactivation recommendation, and/or RAN actions to serve UE 601 the PDU session over the selected network slice. Exemplary slice parameter recommendations include enabling/disabling or increasing/decreasing slice parameters like pre-configuration grant, pre-scheduling, and relative priority scheduling. Exemplary RAN actions include transferring handover commands, transferring RAT reselection commands, transferring band reselection commands, transferring requests to create a new slice, transferring requests to deactivate an existing slice, and the like. Alternatively, the machine learning output may recommend maintaining current slice parameters. When the recommendation includes new slice parameters, RAN 610 modifies service to UE 601 using the recommended slice parameters. When the slice recommendation does not include new slice parameters, RAN 610 maintains the current service level to UE 601. In some examples, RAN 610 processes KPIs reported by UE 601 on behalf of (or in addition to) UE 601. In some examples, RAN 610 instead reports UE and RAN metrics to NWDAF 627 to generate KPIs.

Contemporaneously to UE 601 and RAN 610 generating KPIs, NWDAF 627 generates additional KPIs describing network conditions in network core 620. AMF 621, SMF 622, UPFs 623, NSSF 624, UDM 625, and NSMF 626 are subscribed to NWDAF 627 for analytics reporting. These network functions report metrics like signaling load, throughput, type geographic location, network location, and the like to NWDAF 627. NWDAF 627 processes the reported metrics to generate KPIs describing network conditions in the core 620. The KPIs may describe available slice types, network slice compositions, network function load, network function type, number of instantiated network function, network function capabilities, network core topology, and the like. NWDAF 627 generates a KPI report comprising the network core KPIs to MLF 628. In some examples, NWDAF 627 may additionally receive metrics from RAN 610 and/or UE 601 and generate KPIs on behalf of (or in addition to) UE 601 and RAN 610.

MLF 628 is representative of a network function to generate machine learning outputs based on data received from NWDAF 628. MLF 628 comprises artificial intelligence/machine learning algorithms trained to recommend slice parameters, create new slices, and deactivate existing slices based on network conditions. MLF 628 receives the network KPIs from NWDAF 627 and converts the KPIs into feature vectors. MLF 628 processes the feature vectors using its machine learning algorithms and generates a machine learning output to manage slices in network 600. The machine learning output may include recommended slice parameters, recommended UE/RAN actions, and/or recommended core actions. Exemplary slice parameters recommendations include enabling/disabling or increasing/decreasing slice parameters on RAN 610 like pre-configuration grant, pre-scheduling, relative priority scheduling, and the like. Exemplary UE/RAN actions include handover, band reselection, RAT type reselection, instantiating a new slice for UE 601, moving UE 601 to a more suitable network slice, removing the slice for UE 601, and the like. Exemplary core actions include instantiating/deactivating network function instances, instantiating new slices, deactivating existing slices, and the like. MLF 628 provides the recommendation to AMF 621.

AMF 621 receives the recommendation from MLF 628 and enforces the slice policies recommended by MLF 628. When the recommendation includes a modification to RAN 610, AMF 621 directs RAN 610 to modify its service over the slice to UE 601 accordingly. When the recommendation selects a new slice for UE 601, AMF 621 transfers Non-Access Stratum (NAS) signaling to UE 601 to switch to the recommended slice. When the recommendation includes a UE or RAN action, AMF 621 transfers signaling to RAN 610 and/or UE 601 to take the recommended action (e.g., handover). When the recommendation indicates slice deactivation/slice removal for UE 601, AMF 621 kicks UE 601 off of the slice and/or interfaces with NSMF 626 to spin down the slice. It should be appreciated that by including machine learning elements in UE 610, RAN 610, and core 620, the machine learning models may obtain an end-to-end view of conditions in network 600. In some examples, MLF 628 instead transfers the machine learning output to a PCF (not illustrated) which enforces the updated slice parameters in core 620.

When MLF 628 recommends generating a new slice, AMF 621 interfaces with NSMF 626 to instantiate the new network slice. The new slice recommendation includes parameters (e.g., slice type, QoS, network location, composition, etc.) for the new network slice. NSMF 626 manages the available network slices in core 620 and instantiates new network slices when required. NSMF 626 transfers a request to OAM (not illustrated) to reserve computing resources for the new network slice. The request includes the service parameters for the new slice. The OAM reserves hardware resources in network core 620 to create additional UPF(s) (and potentially other network functions) for the new network slice. Network core 620 instantiates new network functions using the hardware resources allocated by the OAM. NSMF 626 generates the new network slice using the newly spun up network functions and assigns an S-NSSAI for the new slice. NSMF 626 notifies AMF 621 that the new slice is created. AMF 621 transfers NAS signaling to UE 601 to switch to the newly created slice.

In some examples, when UE 601 first attaches to network core 620 over RAN 610, UE 601 may request a slice type not available on network 600. For example, during registration NSSF 624 may indicate to AMF 621 the slice(s) requested by UE 601 is not currently available. In such examples, AMF 621 may provide the requested slice type and other metrics like requested PDU session type, PDU session requirements, UE capabilities, current radio conditions, current RAN/core conditions, required radio conditions, required RAN/core conditions, and/or other KPIs to MLF 628. MLF 628 converts the received KPIs into feature vectors and processes the feature vectors using its constituent machine learning algorithms to generate a machine learning output. The output may recommend a suitable substitute slice (e.g., a substitute S-NSSAI) or may recommend the creation of a new network slice to serve UE 601. When the output recommends a substitute slice, MLF 628 returns the S-NSSAI for the substitute slice to AMF 621 which then registers UE 601 for service on that slice. When the output recommends creating a new slice, MLF 628 notifies AMF 621 and recommends parameters (e.g., bit rate, latency, RAN features etc.) for the new slice. AMF 621 interfaces with NSMF 626 to instantiate the new network slice as described above. Once created, AMF 621 registers UE 601 for service on the newly created slice. In some examples, the newly created slice may comprise a temporary slice. For example, the output received from MLF 628 may recommend creating a temporary slice to serve UE 601 for the duration of the PDU session that is deactivated in response to session termination. When the temporary network slice is no longer needed (e.g., in response to deregistration by UE 601), NSMF 627 interfaces with OAM to deactivate the temporary slice.

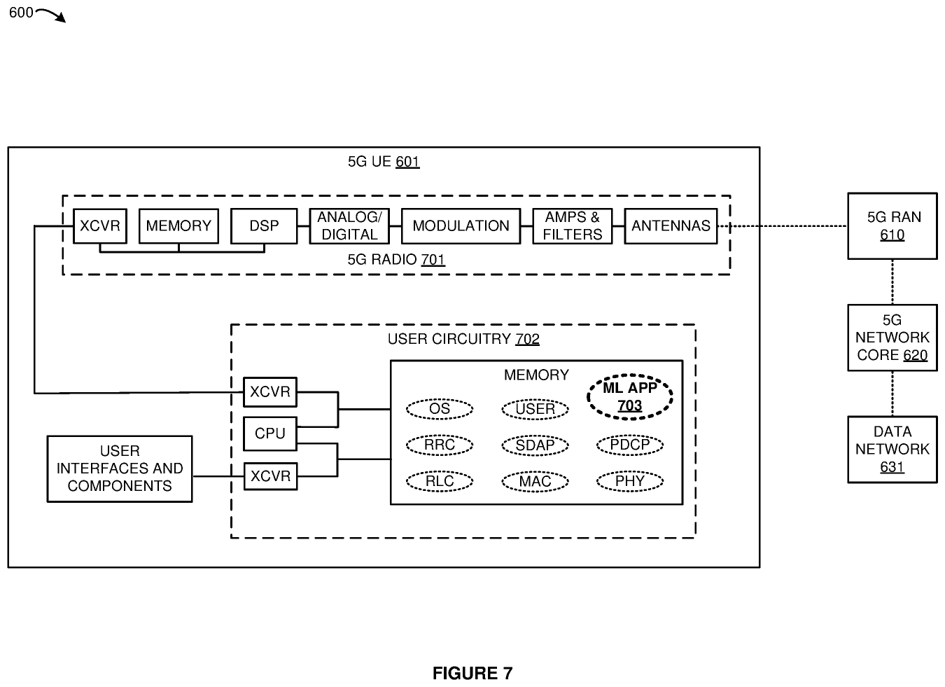

FIG. 7 illustrates 5G UE 601 in 5G communication network 600. UE 601 comprises an example of user device 101 illustrated in FIG. 1 and UE 301 illustrated in FIG. 3, although user device 101 and UE 301 may differ. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), and machine learning application (ML APP) 703, and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). Machine learning application 703 functions comprise network condition KPI collection, network condition KPI reporting, and slice recommendation generation.

In some examples, machine learning application 703 interfaces with the RRC and the user application to generate KPIs that describe network conditions at the location of UE 601. The RRC controls the low-layer radio applications (e.g., PHY) to measure RSRP, RSRQ, and SINR. The RRC tracks the current transmit power and power headroom for radio 701. The RRC reports the KPIs to machine learning application 703. The user application (or SDAP) reports the received latency and downlink throughput for the PDU session to machine learning application 703. Application 703 may process the KPIs using machine learning algorithms hosted by UE 601 to generate a machine learning recommendation to modify parameters of UE 601's network slice or to perform some action (e.g., handover, band reselection, slice reselection, etc.) by UE 601. Application 703 drives UE 601 to transfer the recommended slice parameters to RAN 610. Alternatively, application 703 may form a report comprising the KPIs collected from the RRC and user application and drive UE 601 to transfer the report to RAN 610 or core 620 for processing.

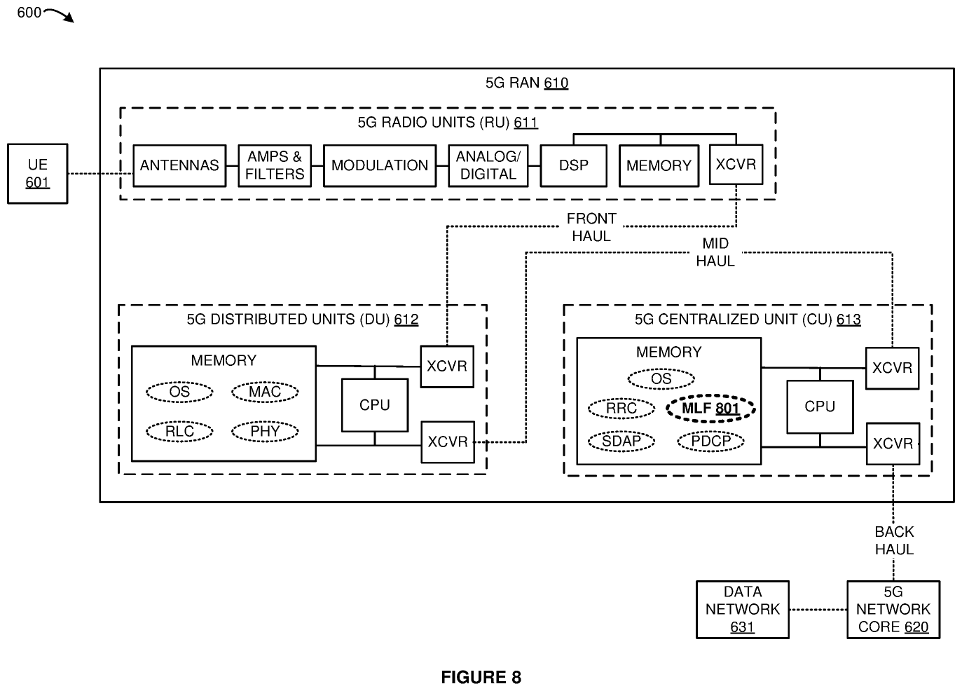

FIG. 8 illustrates 5G RU 611, 5G DU 612, and 5G CU 613 in 5G communication network 600. RU 611, DU 612, and CU 613 comprise an example of the access network 111 and RAN 310, although access network 111 and RAN 310 may differ. RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system and Machine Learning Function (MLF) 801, and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection. MLF 801 functions comprise network condition KPI collection, network condition KPI reporting, and slice recommendation generation.

In some examples, MLF 801 collects KPIs describing network conditions in RAN 610 from the network applications hosted by DU 612 and CU 613. The RRC interfaces with the lower-layer network functions to generate KPIs like cell loading, backhaul link conditions, downlink throughput, downlink data queues, and the like. The RRC reports the collected KPIs to MLF 801. MLF 801 generates feature vectors that numerically represent the KPIs processes the feature vectors using its constituent algorithms to generate a machine learning output. The output recommends updated slice parameters and/or actions to serve UE 601 the PDU session over UE 601's network slice. For example, loading on RAN 610 may be light indicating excellent network conditions and the slice used by UE 601 may include relative priority scheduling as a default attribute. Given the excellent network conditions, MLF 801 may generate an output that recommends disabling relative priority scheduling for UE 601 to conserve RAN resources while maintaining data throughput to UE 601. The RRC in CU 613 may then receive the recommendation and disable relative priority scheduling for UE 601.

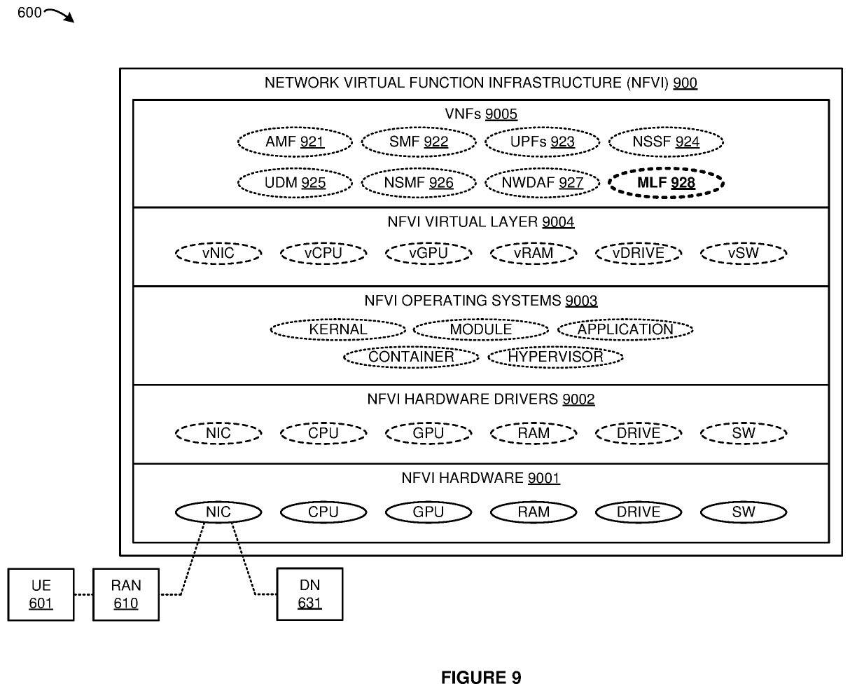

FIG. 9 illustrates Network Function Virtualization Infrastructure (NFVI) 900 in 5G wireless communication network 600. NFVI 900 comprises an example of core network 120 illustrated in FIG. 1 and network circuitry 320 illustrated in FIG. 3, although core network 120 and network circuitry 320 may differ. NFVI 900 comprises NFVI hardware 901, NFVI hardware drivers 902, NFVI operating systems 903, NFVI virtual layer 904, and NFVI Virtual Network Functions (VNFs) 905. NFVI hardware 901 comprises Network Interface Cards (NICs), CPU, GPU, RAM, Flash/Disk Drives (DRIVE), and Data Switches (SW). NFVI hardware drivers 902 comprise software that is resident in the NIC, CPU, GPU, RAM, DRIVE, and SW. NFVI operating systems 903 comprise kernels, modules, applications, containers, hypervisors, and the like. NFVI virtual layer 904 comprises vNIC, vCPU, vGPU, vRAM, vDRIVE, and vSW. NFVI VNFs 905 comprise AMF 921, SMF 922, UPFs 923, NSSF 924, UDM 925, NSMF 926, NWDAF 927, and MLF 928. Additional VNFs and network elements like AUSF, UDR, NRF, PCF, NEF, AF, SCP, and EIR are typically present but are omitted for clarity. NFVI 900 may be located at a single site or be distributed across multiple geographic locations. The NIC in NFVI hardware 901 is coupled to RAN 610 and to data network 631. NFVI hardware 901 executes NFVI hardware drivers 902, NFVI operating systems 903, NFVI virtual layer 904, and NFVI VNFs 905 to form AMF 611, SMF 622, UPFs 623, NSSF 624, UDM 625, NSMF 626, NWDAF 627, and MLF 628.

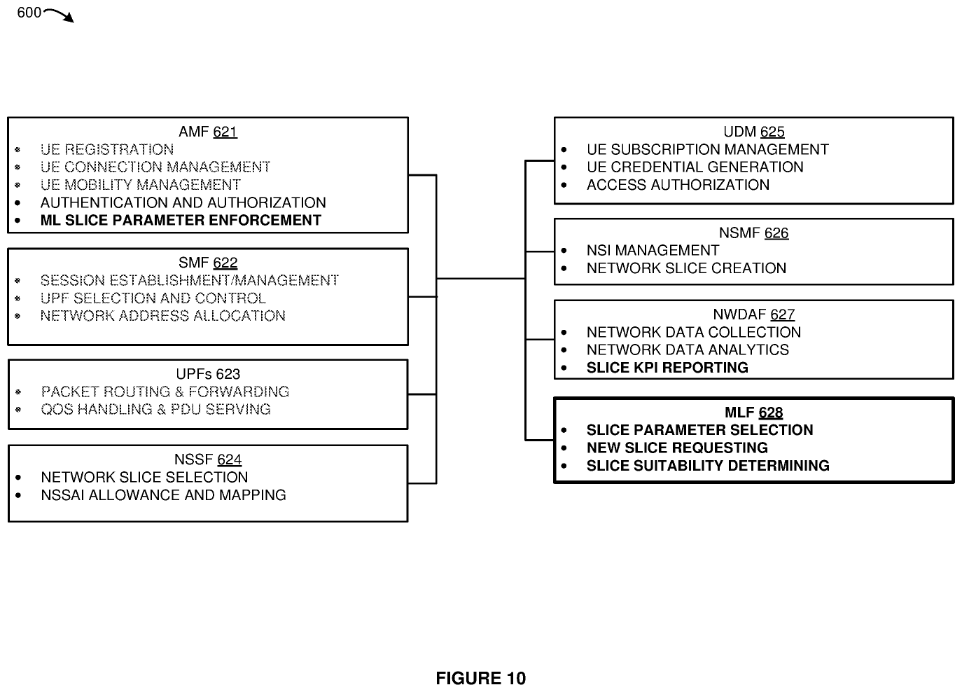

FIG. 10 further illustrates NFVI 900 in 5G communication network 600. AMF 621 comprises capabilities for UE registration, UE connection management, UE mobility management, authentication, authorization, and machine learning slice parameter enforcement. SMF 622 comprises capabilities for session establishment, session management, UPF selection, UPF control, and network address allocation. UPFs 623 comprise capabilities for packet routing, packet forwarding, QoS handling, and PDU serving. NSSF 624 comprises capabilities for network slice selection, NSSAI allowance, and NSSAI mapping. UDM 625 comprises capabilities for UE subscription management, UE credential generation, and UE access authorization. NSMF 626 comprises capabilities for Network Slice Instance (NSI) management and network slice creation. NWDAF 627 comprises capabilities for network data collection, network data analytics, and slice KPI reporting. MLF 628 comprises capabilities for slice parameter selection, new slice requesting, and slice suitability determining.

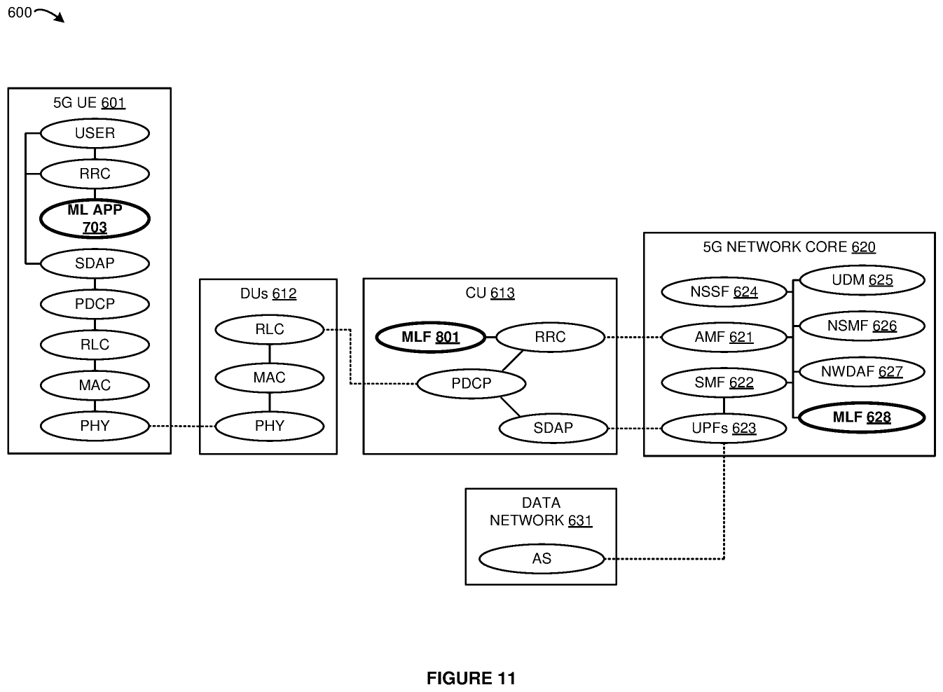

FIG. 11 illustrates an exemplary operation of 5G communication network 600 to perform machine learning slice parameter selection based on network conditions. The operation of network 600 may vary in other examples. In some examples, UE 601 wirelessly attaches to RAN 610. The RRC in UE 601 transfers a registration request to the RRC in CU 613 over the PDCPs, RLCs, MACs, and PHYs which forwards the request to AMF 621. AMF 621 responds to the request by transferring an identity request to the RRC in CU 613. The RRC in CU 613 forwards the identity request to the RRC in UE 601 over the PDCPs, RLCs, MACs, and PHYs. The RRC in UE 601 returns its SUCI to the RRC in CU 613 over the PDCPs, RLCs, MACs, and PHYs which forwards the SUCI to AMF 621. AMF 621 interfaces with other network functions (e.g., AUSF and UDM 625) to authenticate UE 601 and authorize UE 601 for wireless data service. Responsive to the authentication and authorization, AMF 621 registers UE 601. AMF 621 accesses a subscriber profile for UE 601 from UDM 625 to generate UE context to serve UE 601. Once the context is generated, AMF 621 selects NSSF 624 to select a network slice for UE 601. AMF 621 transfers a get request to NSSF 624 to map the NSSAI requested by UE 601 to an available network slice in network core 620. NSSF 624 maps the NSSAI to the network slice and returns the slice mappings to AMF 621 which then selects the network slice for UE 601.

AMF 621 selects SMF 622 to serve UE 601 and directs SMF 622 to establish PDU a session for UE 601. AMF 621 indicates the S-NSSAI for the selected network slice to SMF 622. SMF 622 selects the one of UPFs 623 to serve UE 601 based on the S-NSSAI. SMF 622 indicates the network address for the selected one of UPFs 623 to AMF 621. AMF 621 includes the network address in the UE contexts and transfers the context to the RRC in CU 613. The RRC forwards the context to the RRC in UE 601 over the PDCPs, RLCs, MACs, and PHYs. In response to user inputs, UE 601 launches a user application. The RRC in UE 601 uses the received UE context to establish the PDU session. The RRC directs the SDAP to begin the PDU session for the user application over the network slice. The user application generates uplink data and the SDAP transfers the uplink data to the SDAP in CU 613 over the PDCPs, RLCs, MACs, and PHYs which transfers the uplink data to the corresponding one of UPFs 623. The corresponding one of UPFs 623 transfers the uplink user data to data network 631. Data network 631 generates downlink data for the PDU session and transfers the downlink data to the corresponding one of UPFs 623. The corresponding one of UPFs 623 transfers the downlink user data to the SDAP in CU 613. The SDAP transfers the downlink data to the SDAP in UE 601 over the PDCPs, RLCs, MACs, and PHYs.

As UE 601 participates in its PDU session, the RRC in UE 601 directs the PHY to measures RSRP, RSRQ, and SINR for the signal received from RAN 610. The PHY measures the radio metrics and reports the metrics to the RRC. The RRC determines transmit power and power headroom for radio 701 in UE 601. The SDAP obtains application performance metrics for the PDU session including uplink throughput, downlink throughput, and received latency. The RRC and SDAP provide the obtained KPIs to machine learning application 703. Machine learning application 703 converts the KPIs into feature vectors and processes the feature vectors using its constituent algorithms to generate a machine learning output. Application 703 provides the output to the RRC in UE 601 which modifies the behavior of UE 601 and/or transfers a request to modify the network slice to RAN 610 based on recommended slice parameters included in the output.

As RAN 610 serves the network slice to UE 601, the RRC in CU 613 generates KPIs describing network conditions in RAN 610. The RRC measures cell loading, backhaul link conditions, downlink throughput, and downlink data queues. The RRC provides these KPIs to MLF 801. MLF 801 converts the KPIs into feature vectors and processes the feature vectors using its constituent machine learning algorithms to generate a machine learning output. MLF 801 provides the output to the RRC in CU 613 which modifies the service to UE 601 based on recommended slice parameters included in the output.

As core 620 serves the network slice to UE 601 over RAN 610, NWDAF 627 collects signaling load, throughput, type geographic location, network location, from the other network functions in core 620. NWDAF 627 processes the metrics to generate KPIs that describe network conditions in the core 620. The KPIs include available slice types, network slice compositions, network function load, network function type, number of instantiated network functions by type, network function capabilities, and network core topology. NWDAF 627 provides the KPIs to MLF 628. MLF 628 converts the KPIs into feature vectors and processes the feature vectors using its machine learning algorithms to generate a machine learning output that comprises recommended slice parameters. MLF 628 provides the output to AMF 621. AMF 621 enforces the slice parameters recommended by MLF 628 on RAN 610 and/or in core 620. In some examples, MLF 628 instead provides the output to a PCF which enforces the slice parameters in core 620.

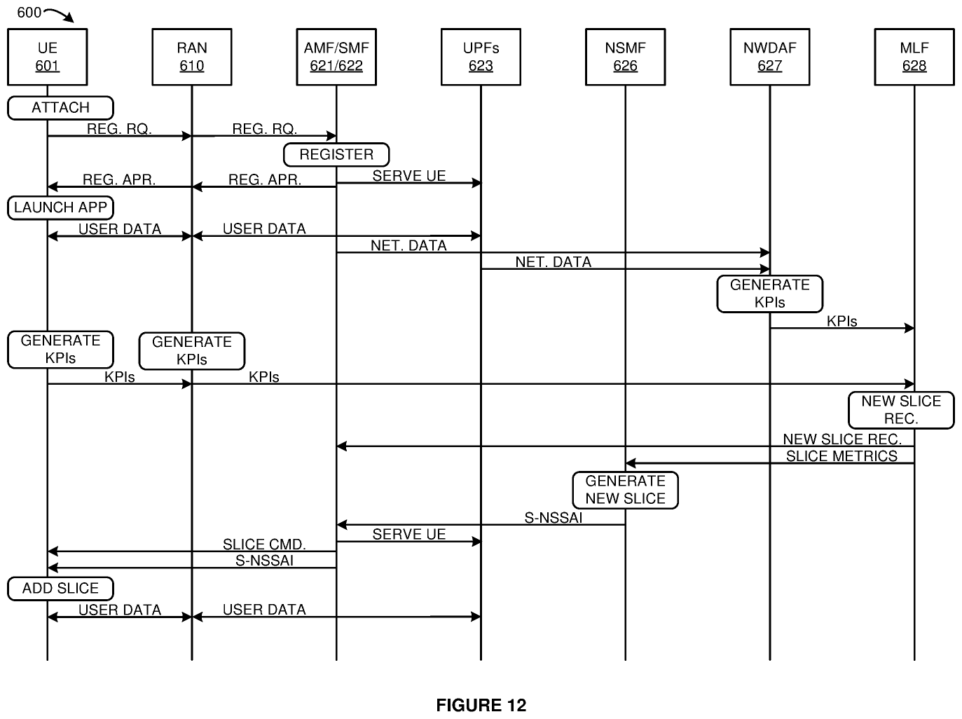

FIG. 12 illustrates an exemplary operation of 5G communication network 600 to perform machine learning network slice addition based on network conditions. The operation of network 600 may vary in other examples. In some examples, UE 601 attaches to RAN 610 and transfers a registration request to AMF 621. The registration request does not include any slice requests. For example, UE 601 may request a minimum QoS PDU session that does not require network slicing. AMF 621 interfaces with the other network functions in core 620 to register UE 601. In response to authentication and authorization, AMF 621 directs SMF 622 to serve UE 601. SMF 622 selects one of UPFs 623 to serve UE 601. AMF 621 transfers a registration approval message to UE 601 over RAN 610. UE 601 begins its PDU session and exchanges user data with the UPF over RAN 610. As UE 601 participates in its PDU session, AMF 621, SMF 622, and UPFs 623 report network data to NWDAF 627. The network data indicates signaling load, throughput, geographic location, network location, and the like. NWDAF 627 generates KPIs based on the reported data. NWDAF 627 reports the network KPIs to MLF 628. Contemporaneously, UE 601 and RAN 610 generate KPIs that describe network conditions at UE 601 and at RAN 610. UE 601 generates KPIs like RSRP, RSRQ, SINR, UE capabilities, transmit power, power headroom, downlink/uplink throughput, received latency, required latency, required throughput, and the like. RAN 610 generates KPIs like cell loading, backhaul link conditions, downlink/uplink throughput, downlink data queues, and the like. UE 601 and RAN 610 report their KPIs to MLF 628. Alternatively, UE 601 and RAN 610 may process their respective KPIs locally using their machine learning capabilities (e.g., by using machine learning application 703 and/or MLF 801).

MLF 628 converts the received KPIs into feature vectors and processes the feature vectors using its constituent machine learning algorithms. MLF 628 generates an output that recommends creating a network slice for UE 601 and includes slice metrics that define the level of service for the new slice. For example, the KPIs reported by UE 601, RAN 610, and/or NWDAF 627 may indicate network conditions are insufficient to maintain the level of service for UE 601's PDU session. In response, MLF 628 may generate a recommendation to create a slice for UE 601 to ensure the level of service provided to UE 601 does not degrade. MLF 628 transfers the new slice recommendation to AMF 621 and transfers service metrics for the new slice to NSMF 626. NSMF 626 generates a new slice with the recommended service metrics and assigns an S-NSSAI to the new slice. NSMF 626 reports the S-NSSAI to AMF 621. AMF 621 directs SMF 622 to serve UE 601 on the new slice. SMF 622 directs the one of UPFs 623 that corresponds to the new slice to serve UE 601. AMF 621 transfers a command to add the new slice and indicates the S-NSSAI for the new slice to UE 601. UE 601 adds the new slice and continues its PDU session on the slice. UE 601 exchanges user data on the slice with RAN 610. RAN 610 exchanges the user data with the UPF.

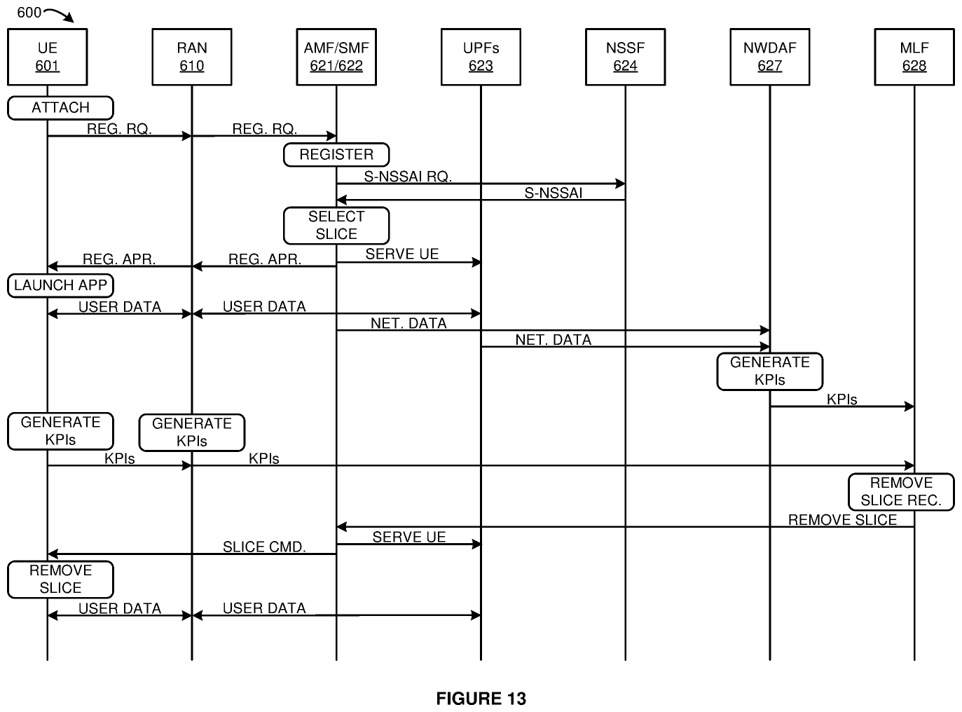

FIG. 13 illustrates an exemplary operation of 5G communication network 600 to perform machine learning network slice removal based on network conditions. The operation of network 600 may vary in other examples. In some examples, UE 601 attaches to RAN 610 and transfers a registration request to AMF 621. The registration request includes a slice request. For example, UE 601 may request a low-latency PDU session and include the S-NSSAI for a URLLC slice in the registration request. AMF 621 interfaces with the other network functions in core 620 to register UE 601. In response to authentication and authorization, AMF 621 interfaces with NSSF 624 to select a network slice for UE 601. NSSF 624 maps the requested S-NSSAI by UE 601 to an S-NSSAI for an available slice in core 620 and reports the S-NSSAI for the slice to AMF 621. AMF 621 directs SMF 622 to serve UE 601 the selected network slice. SMF 622 directs the one of UPFs 623 that corresponds to the slice to serve UE 623. AMF 621 transfers a registration approval message to UE 601 over RAN 610. UE 601 begins the PDU session over the slice and exchanges user data with the UPF over RAN 610. As UE 601 participates in its PDU session, AMF 621, SMF 622, and UPFs 623 report network data to NWDAF 627. The network data indicates signaling load, throughput, type geographic location, network location. NWDAF 627 generates KPIs based on the reported data. NWDAF 627 reports the network KPIs to MLF 628. Contemporaneously, UE 601 and RAN 610 generate KPIs that describe network conditions at UE 601 and at RAN 610. UE 601 generates KPIs like RSRP, RSRQ, SINR, UE capabilities, transmit power, power headroom, uplink/downlink throughput, slice type, received latency, required latency, and required throughput. RAN 610 generates KPIs like cell loading, backhaul link conditions, uplink/downlink throughput, downlink data queues, and the like. UE 601 and RAN 610 report their KPIs to MLF 628. Alternatively, UE 601 and RAN 610 may process their respective KPIs locally using their machine learning capabilities.

MLF 628 converts the received KPIs into feature vectors and processes the feature vectors using its constituent machine learning algorithms. MLF 628 generates an output that recommends removing the network slice for UE 601. For example, the KPIs reported by UE 601, RAN 610, and/or NWDAF 627 may indicate network conditions are sufficient to maintain the level of service for UE 601's PDU session without network slicing. In response, MLF 628 may generate a recommendation to kick UE 601 off of the slice or to deactivate the slice entirely. MLF 628 transfers the remove slice recommendation to AMF 621. AMF 621 directs SMF 622 to remove UE 601 from the network slice. SMF 622 directs one of UPFs 623 that does not comprise the current network slice to serve UE 601. AMF 621 transfers a command to remove the slice to UE 601. UE 601 removes the slice and continues its PDU session on the new UPF. UE 601 exchanges user data with RAN 610. RAN 610 exchanges the user data with the UPF.

The wireless data network circuitry described above comprises computer hardware and software that form special-purpose network circuitry to perform machine learning slice parameter selection based on network conditions. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to perform machine learning slice parameter selection based on network conditions.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
generating feature vectors based on Key Performance Indicator (KPI) values associated with network conditions for an access network, wherein the access network comprises a network slice;
providing the feature vectors to a machine learning model trained to output values corresponding to slice parameters associated with the network slice;
configuring the slice parameters of the network slice using the values output by the machine learning model; and
serving a wireless user device over the network slice.

2. The method of claim 1 further comprising obtaining the KPI values associated with the network conditions for the access network via a measurement report generated by the wireless user device that characterizes radio conditions for the access network.

3. The method of claim 1 further comprising obtaining the KPI values associated with the network conditions for the access network by generating loading data that characterizes cell loading on the access network.

4. The method of claim 1 wherein:
the machine learning output comprises a pre-configuration grant parameter for the network slice; and
configuring the slice parameters of the network slice using the values output by the machine learning model comprises configuring a pre-configuration grant parameter of the network slice using the values output by the machine learning model.

5. The method of claim 1 wherein:
the machine learning output comprises a pre-scheduling parameter for the network slice; and
configuring the slice parameters of the network slice using the values output by the machine learning model comprises configuring a pre-scheduling parameter for the network slice using the values output by the machine learning model.

6. The method of claim 1 wherein:
the machine learning output comprises a relative priority scheduling parameter for the network slice; and
configuring the slice parameters of the network slice using the values output by the machine learning model comprises configuring an existing relative priority scheduling parameter for the network slice using the values output by the machine learning model.

7. The method of claim 1 wherein:
the machine learning output comprises the slice parameters and a recommendation to create a new network slice;
configuring the slice parameters of the network slice using the values output by the machine learning model comprises generating a request to create the new network slice using the slice parameters obtained in the machine learning output; and
serving the wireless user device over the network slice comprises serving the wireless user device over the new network slice.

8. A wireless communication network comprising:
access network circuitry to:
generate feature vectors based on Key Performance Indicator (KPI) values associated with network conditions for an access network, wherein the access network comprises a network slice;
provide the feature vectors to a machine learning model trained to output values corresponding to slice parameters associated with the network slice;
configure the slice parameters of the network slice using the values output by the machine learning model; and
serve a wireless user device over the network slice.

9. The wireless communication network of claim 8 wherein the access network circuitry is to receive a measurement report generated by the wireless user device that characterizes radio conditions for the access network.

10. The wireless communication network of claim 8 wherein the access network circuitry is to determine loading data that characterizes cell loading on the access network.

11. The wireless communication network of claim 8 wherein:
the machine learning output comprises a pre-configuration grant parameter for the network slice; and
the access network circuitry is to:
configure the network slice using the pre-configuration grant parameter output by the machine learning model.

12. The wireless communication network of claim 8 wherein:
the machine learning output comprises a pre-scheduling parameter for the network slice; and
the access network circuitry is to:
configure the network slice using the pre-scheduling parameter output by the machine learning model.

13. The wireless communication network of claim 8 wherein:
the machine learning output comprises a relative priority scheduling parameter for the network slice; and
the access network circuitry is to:
configured the network slice using the relative priority scheduling parameter output by the machine learning model.

14. The wireless communication network of claim 8 wherein:
the machine learning output comprises the slice parameters and a recommendation to create a new network slice;
the access network circuitry is to:
responsive to creation of the new network slice, serve the wireless user device over the new network slice; and further comprising:
control plane circuitry to:
generate a request to create the new network slice using the slice parameters obtained in the machine learning output.

15. One of more non-transitory computer readable storage media having program instructions stored thereon, wherein the program instruction, when executed by a computing system, direct the computing system to perform operations, the operations comprising:
generating feature vectors based on Key Performance Indicator (KPI) values associated with network conditions for an access network, wherein the access network comprises a network slice;
providing the feature vectors to a machine learning model trained to output values corresponding to slice parameters associated with the network slice;
configuring the slice parameters of the network slice using the values output by the machine learning model; and
serving a wireless user device over the network slice.

16. The computer readable storage media of claim 15, the operations further comprising:
obtaining the KPI values associated with the network conditions for the access network via a measurement report generated by the wireless user device that characterizes radio conditions for the access network; and
obtaining the KPI values associated with the network conditions for the access network by generating loading data that characterizes cell loading on the access network.

17. The computer readable storage media of claim 15 wherein:
the machine learning output comprises a pre-configuration grant parameter for the network slice; and
configuring the slice parameters of the network slice using the values output by the machine learning model comprises configuring a pre-configuration grant parameter of the network slice using the values output by the machine learning model.

18. The computer readable storage media of claim 15 wherein:
the machine learning output comprises a pre-scheduling parameter for the network slice; and
configuring the slice parameters of the network slice using the values output by the machine learning model comprises configuring a pre-scheduling parameter for the network slice using the values output by the machine learning model.

19. The computer readable storage media of claim 15 wherein:
the machine learning output comprises a relative priority scheduling parameter for the network slice; and
configuring the slice parameters of the network slice using the values output by the machine learning model comprises configuring an existing relative priority scheduling parameter for the network slice using the values output by the machine learning model.

20. The computer readable storage media of claim 15, the operations further comprising:
generating additional feature vectors based on additional KPI values associated with the network conditions for the access network;
providing the additional feature vectors to the machine learning model trained to output the values corresponding to the slice parameters associated with the network slice; and
removing the network slice for the wireless user device based on updated values output by the machine learning model.
